(19) United States
(12) Patent Application Publication
(10) Pub. No.: US 2016/0136822 A1
(43) Pub. Date: May 19, 2016

(54) ROBOTIC FINGER STRUCTURE

(71) Applicants: HONG FU JIN PRECISION INDUSTRY (ShenZhen) CO., LTD., Shenzhen (CN); HON HAI PRECISION INDUSTRY CO., LTD., New Taipei (TW)

(72) Inventors: MING-CHIEH CHANG, New Taipei (TW); TE-HUA LEE, New Taipei (TW); CHUN-YUAN WANG, Shenzhen (CN)

(21) Appl. No.: 14/944,240

(22) Filed: Nov. 18, 2015

(30) Foreign Application Priority Data
Nov. 18, 2014 (CN) 201410656337.8

(51) Int. Cl. B25J 15/08; G01L 1/20; B25J 9/16

(52) U.S. Cl. CPC B25J 15/08; B25J 9/1694; B25J 9/1612; G01L 1/20; Y10S 901/10

(57) ABSTRACT

A robotic finger structure is a section of a robotically controlled extension including a fingertip and a tactile sensor, the fingertip has a finger pulp, and the tactile sensor is integrated with the surface of the finger pulp. The tactile sensor configured to form a detecting area to accept and indicate any pressure on a plane perpendicular between the tactile sensor and an object; therefore the tactile sensor can feed back the force of pressure accurately, and control overall gripping force of the robotic finger.

### FIELD

The subject matter herein generally relates to object handling.

### BACKGROUND

When robotic hands lack any type of touch feedback, mishandling or fracture of the object they are supposed to pick up can occur. Therefore, tactile sensors are used for robotic manipulation and to sense interactions with robotic finger interfaces. These sensors should be capable of detecting when a robotic finger comes in contact with any type of object at any angle. This feature is very important because in general a robot will not have any prior model of the object and must use its hands to contact and learn about the object.

Current robotic fingers use tactile sensors to detect contact, the sensor have a contact-sensitive shape. The sensors also need to deal with this condition by either detecting saturation contact or having a large operating range. After the initial contact with an object, the fingers of a robot exert high forces to handle objects. Many attempts have been made to implement tactile sensing in robots. There are many technologies used to build sensor arrays, for example, a compliant convex surface disposed above a sensor array, and the sensor array adapted to respond to deformation of the convex surface to generate a signal related to an applied force vector. In another example, most sensors are essentially a flexible elastic skin, coupled with a method of measuring the deformation caused by the applied force. However, either the structure of the sensor arrays or the flexible elastic skin is complicated and may be expensive.

### BRIEF DESCRIPTION OF THE DRAWINGS

Implementations of the present technology will now be described, by way of example only, with reference to the attached figures.

FIG. 1 is an isometric view of a robotic finger according to an embodiment of the present disclosure.

FIG. 2 is a cross-sectional view of a tactile sensor of the robotic finger shown in FIG. 1.

FIG. 3 is a cross-sectional view of the robotic finger shown in FIG. 1.

### DETAILED DESCRIPTION

A robotic hand includes an approximation of a human palm and plurality of fingers. Each robotic finger includes a proximal phalange and a distal phalange, wherein the distal phalange have a finger tip positioned on the end portion of the robotic finger. The robotic hand further includes a controller configured to actuate the plurality of robotic fingers and to detect contact by at least one of the plurality of robotic fingers with an object by sensing changes in the compliant torque of at least one of the plurality of robotic fingers. The controller is further configured to cause at least one of the actuators of the plurality of robotic fingers to exert a compliant torque on at least one of the plurality of robotic fingers to exert a force on the object.

An example embodiment of the present disclosure is described in relation to a structure of robotic finger. The robotic fingers exert a force on an object which is sensed by tactile sensor that is positioned on the fingertip of the robotic finger.

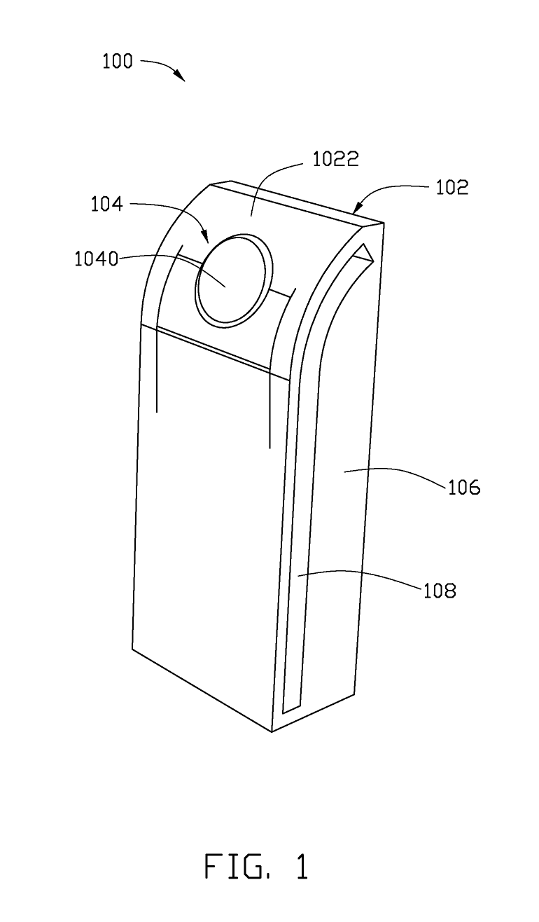

FIG. 1 illustrates an embodiment of a robotic finger 100, the robotic finger 100 is a section of a robotically controlled extension, the robotic finger 100 comprising a fingertip 102 and a tactile sensor 104, the fingertip 102 being located on the end portion of the robotic finger 100 and mounted on a base 106 of the robotic finger 100. Between the base 106 and the fingertip 102 there is a gap 108 that contains a conductive lead or leads (not shown) of the tactile sensor 104. The conductive leads output a signal related to a pressure sensed by the tactile sensor 104.

The fingertip 102 is a body with a first end and a second end, the first end of the body is movably connectable to the robotically controlled extension allowing the section to be robotically controlled. The second end has a contact portion, the contact portion inside of the robotic finger 100, the contact portion of the second end of the body includes a flexible surface and the tactile sensor 104 is integrated with the flexible surface of the second end of the body. In another word, the contact portion such as a finger pulp 1022 mimics the size and shape of the human equivalent, and the tactile sensor 104 is integrated with the surface of the finger pulp 1022. The finger pulp 1022 is made of flexible material, such as but not limited to rubber. The tactile sensor 104 is connectable to the robotic controller (not shown) to control movement of the extension, the tactile sensor 104 configured to form a detecting area 1040 that is convex in shape on the flexible surface of the contact portion of the second end of the body. That is, the detecting area 1040 is convex in shape on the surface of the finger pulp 1022. The shape of the detecting area 1040 (in a plane view) is circular.

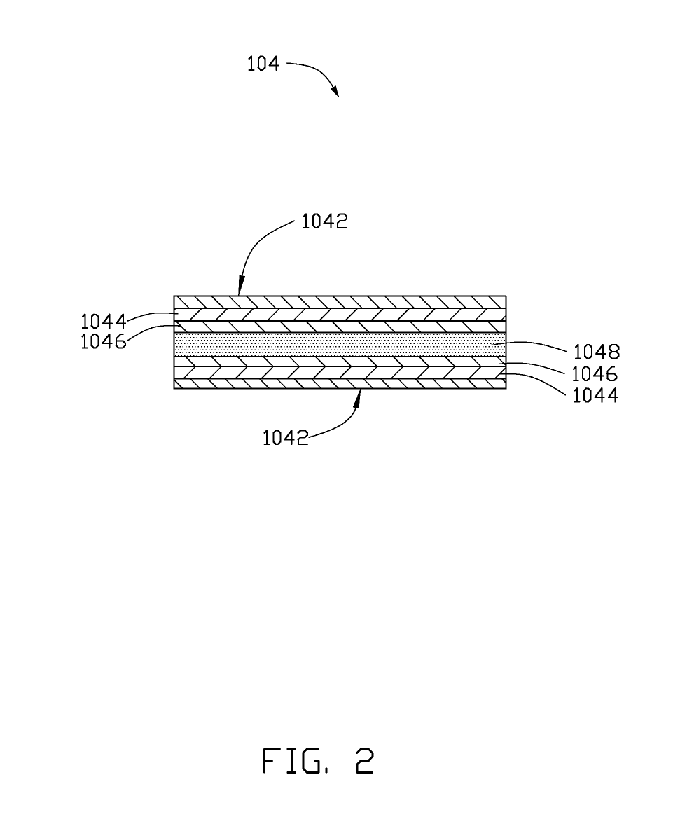

FIG. 2 also illustrates the tactile sensor 104 shown in FIG. 1. The tactile sensor 104 is a force sensing resistor, comprising two layers of a substrate film 1042. The two layers of substrate film 1042 are ultra-thin and laminated together by an adhesive 1048. The material of the substrate film 1042 is polyester; each substrate film 1042 is constructed of a conductive material 1044 and a pressure-sensitive ink 1046. The conductive material 1044 is silver. The conductive material 1044 is on top of the pressure-sensitive ink 1046; the conductive material 1044 extends from the sensing area to a connector (not shown) at other end of the tactile sensor 104 from the conductive leads. When the sensing area of the detecting area 1040 is not subjected to any force, the resistance of the tactile sensor 104 is very high. When any force is applied to the sensing area of the detecting area 1040, the resistance of the tactile sensor 104 resistance decreases. The tactile sensor 104 is adapted to respond to change in the resistance to generate a signal related to the applied force vector, and output the signal to the controller by the conductive leads. The tactile sensor 104 can measure force between two mating surfaces accurately.

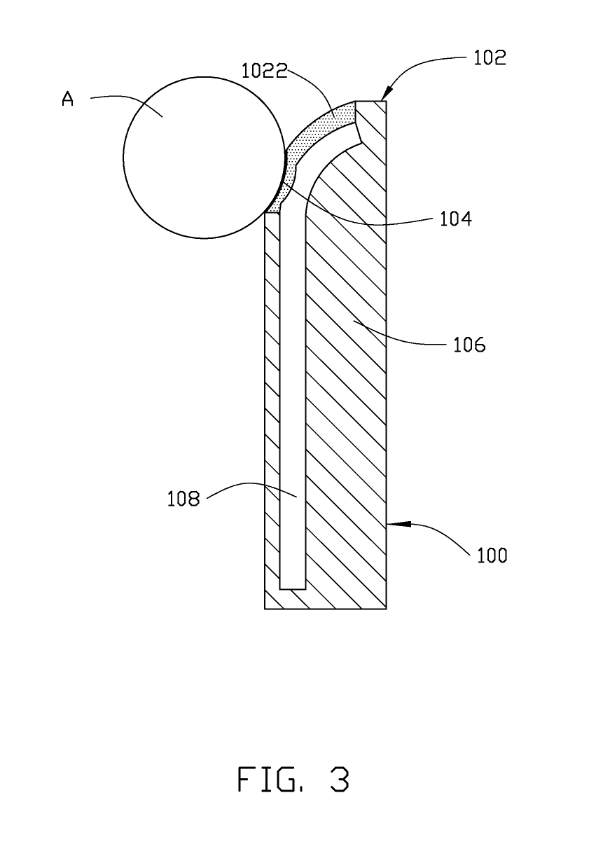

FIG. 3 illustrates the robotic finger shown in FIG. 1 from the side. The tactile sensor 104 contacts an object A, the shape of the object A could be any type. For example, the object A in FIG. 3 is a ball. When the fingertip 102 of robotic finger 100 contacts the surface of object A, the finger pulp 1022 applies a force on the surface of the object A, and the tactile sensor 104 touches the object A surface to measure force between the two mating surfaces. The tactile sensor 104 feeds back the level of force to the controller for actuation of the plurality of robotic fingers 100. The finger pulp 1022 and the tactile sensor 104 can squarely press the curved surface of the object A because they are flexible material, there is full contact between the detecting area 1040 (shown in FIG. 1) of the tactile sensor 104 and the curved surface of the object A, and a perpendicular pressure (shown in FIG. 3) can be sensed by the tactile sensor 104.

The tactile sensor 104 feeds back the perpendicular pressure to the controller, and then the controller can maneuver the robotic fingers 100 to accurately control grip force. The tactile sensor 104 further can have a rough surface or a microstructure (not shown) on the surface of the detecting area 1040, thus when the detecting area 1040 contacts the object A, the rough surface or the microstructure touches the object A surface to increase friction between the robotic finger 100 and the object A, for more stably holding onto the object A. The microstructure of the rough surface is concentric circles or fingerprint ridges. In addition, the tactile sensor 104 may be other type of sensor, for example a heat sensor. Thus when the tactile sensor 104 is a temperature sensor, useful information as to human body temperature, pulse, and heartbeat can be obtained in medical care application.

The structure of the tactile sensor 104 is ultra-thin and flexible; it is easily integrated into the fingertip 102 of robotic finger 100 with ease of production and low cost. The detecting area 1040 of the tactile sensor 104 can measure pressure in a plane which is perpendicular to two mating or virtually mating surfaces accurately and feed information back to the controller, control of the grip force of the robotic finger 100 is improved.

The embodiments shown and described above are only examples. Many details are often found in the art such as the other features of a robotic finger. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, including in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. A robotic finger structure is a section of a robotically controlled extension comprising:
a body with a first end and a second end; and
a tactile sensor;
wherein, the first end of the body is movably connectable to the robotically controlled extension allowing the section to be robotically controlled;
wherein, a contact portion of the second end of the body includes a flexible surface and the tactile sensor is integrated with the flexible surface of the second end of the body; and
wherein, the tactile sensor is connectable to the robotic controller to control movement of the extension.

2. The section of a robotically controlled extension of claim 1 wherein the contact portion of the second end of the body is inside of the robotic finger.

3. The section of a robotically controlled extension of claim 1 wherein the tactile sensor is configured to form a detecting area that is convex in shape on the flexible surface of the contact portion.

4. The section of a robotically controlled extension of claim 3 wherein the detecting area shape is circular.

5. The section of a robotically controlled extension of claim 3 wherein detecting area surface further having a rough surface or a microstructure, the microstructure of the rough surface is concentric circles or fingerprint ridges.

6. The section of a robotically controlled extension of claim 1 wherein the tactile sensor comprises two layers of a substrate film, the two layers of the substrate film laminated together by an adhesive, and each substrate film is constructed of a conductive material and a pressure-sensitive ink.

7. The section of a robotically controlled extension of claim 6 wherein the conductive material is on top of the pressure-sensitive ink from a sensing area.

8. A robotic finger structure comprising:
a fingertip located on the end portion of the robotic finger; and
a tactile sensor,
wherein the fingertip has a finger pulp integrated and combined with the tactile sensor; and
wherein the tactile sensor is configured to form a detecting area that is convex in shape on the surface of the finger pulp.

9. The robotic finger structure of claim 8 wherein the fingertip is mounted on a base of the robotic finger and between the base and the fingertip there is a gap.

10. The robotic finger structure of claim 9 wherein the gap contain a conductive lead or leads of the tactile sensor.

11. The robotic finger structure of claim 8 wherein the finger pulp is inside of the robotic finger, the surface of the finger pulp mimics the size and shape of the human equivalent.

12. The robotic finger structure of claim 11 wherein the finger pulp is made of flexible material.

13. The robotic finger structure of claim 12 wherein the flexible material is rubber.

14. The robotic finger structure of claim 8 wherein the detecting area shape is circular.

15. The robotic finger structure of claim 14 wherein the detecting area surface further having a rough surface or a microstructure, the microstructure of the rough surface is concentric circles or fingerprint ridges.

16. The robotic finger structure of claim 8 wherein the tactile sensor comprises two layers of a substrate film, the two layers of the substrate film laminated together by an adhesive, and each substrate film is constructed of a conductive material and a pressure-sensitive ink.

17. The robotic finger structure of claim 16 wherein the conductive material is on top of the pressure-sensitive ink from a sensing area.

18. The robotic finger structure of claim 16 wherein the substrate film material is polyester.

19. The robotic finger structure of claim 16 wherein the conductive material is silver.
